(19) United States
(12) Patent Application Publication
(10) Pub. No.: US 2006/0286339 A1
(43) Pub. Date: Dec. 21, 2006

(54) Sport cushion

(76) Inventor: Wen-Hsing Chen, Changhua Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/437,971

(22) Filed: May 19, 2006

(30) Foreign Application Priority Data
May 24, 2005 (TW) 094208459

(51) Int. Cl. B32B 3/02

(52) U.S. Cl. 428/68

(57) ABSTRACT

A sport cushion has a hemispherical top, a valve and a supporting base. The hemispherical top has a bottom and an opening defined in bottom. The valve is mounted on the hemispherical top. The supporting base is mounted on the bottom of the hemispherical top to seal the opening. When a player plays on the sport cushion, the sport cushion may be supported by the supporting base and is kept from movement. Furthermore, the sport cushion uses less plastic material, therefore, the cost of producing the sport cushion and the defect rate are both reduced.

### BACKGROUND OF THE INVENTION

1. Field of the Invention

The present invention relates to a sport cushion, and more particularly to a sport cushion being manufactured at a lowered cost.

2. Description of Related Art

A conventional sport cushion has a top and a flat bottom, and is made of a soft plastic material. When a user uses the conventional sport cushion, the shape of the sport cushion is easily deformed to cause the sport cushion to be moved. Therefore, with reference to FIG. 8, another conventional sport cushion (40) is provided to solve the aforementioned problems and has a flat bottom (41), a hemispherical top (42), a valve (44) and a supporting base (45). The hemispherical top (42) is integrally formed on the flat bottom (41) and an air bag (43) is formed between the flat bottom (41) and the hemispherical top (42). The valve (44) is mounted on the hemispherical top (42). The supporting base (45) is mounted on the flat bottom (41).

When using the conventional sport cushion (40), the sport cushion (40) will not move easily due to an anti-movement function provided by the flat bottom (41) and the supporting base (45). However, the disadvantages of the conventional sport cushion (40) are:

1. The technique of mounting the supporting base (45) inside the sport cushion (40) is difficult and the defect rate is high. However, without the supporting base (45), the sport cushion (40) would move easily when using.

2. Because the supporting base (45) is mounted on the bottom of the sport cushion (40), to form a bottom for mounting the supporting base (45) takes much plastic material and the cost for fabricating the sporting cushion (40) is high.

To overcome the shortcomings, the present invention tends to provide a sport cushion to mitigate the aforementioned problems.

### SUMMARY OF THE INVENTION

The primary objective of the present invention is to provide a sport cushion that is conveniently manufactured and can reduce defect rate during fabricating.

The sport cushion has a hemispherical top, a valve and a supporting base. The hemispherical top has a bottom and an opening defined in bottom. The valve is mounted on the hemisphere top. The supporting base is mounted on the bottom of the hemisphere top to seal the opening.

When a player uses the sport cushion, the sport cushion is supported by the supporting base and is kept from movement. Furthermore, the sport cushion uses less plastic material, therefore, the cost of producing the sport cushion is less and the defect-free rate will be promoted.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional plan view of a first embodiment of a sport cushion in accordance with the present invention;

FIG. 2 is a perspective view of the sport cushion in FIG. 1;

FIG. 3 is an operational plan view of the sport cushion in FIG. 1;

FIG. 4 is a cross sectional side plan view of a second embodiment of a sport cushion in accordance with the present invention;

FIG. 5 is a cross sectional side plan view of a third embodiment of a sport cushion in accordance with the present invention;

FIG. 6 is a cross sectional side plan view of a forth embodiment of a sport cushion in accordance with the present invention;

FIG. 7 is a cross sectional side plan view of a fifth embodiment of a sport cushion in accordance with the present invention; and

FIG. 8 is a cross sectional side plan view of a conventional sport cushion in accordance with the prior art.

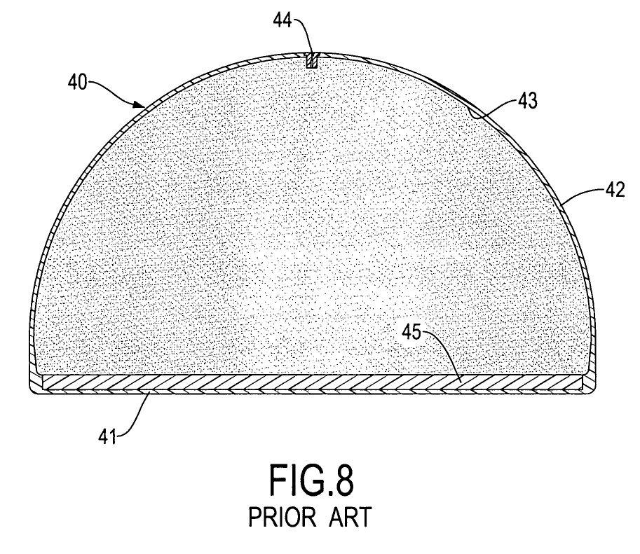

### DETAILED DESCRIPTION OF THE PREFERRED EMBODIMENT

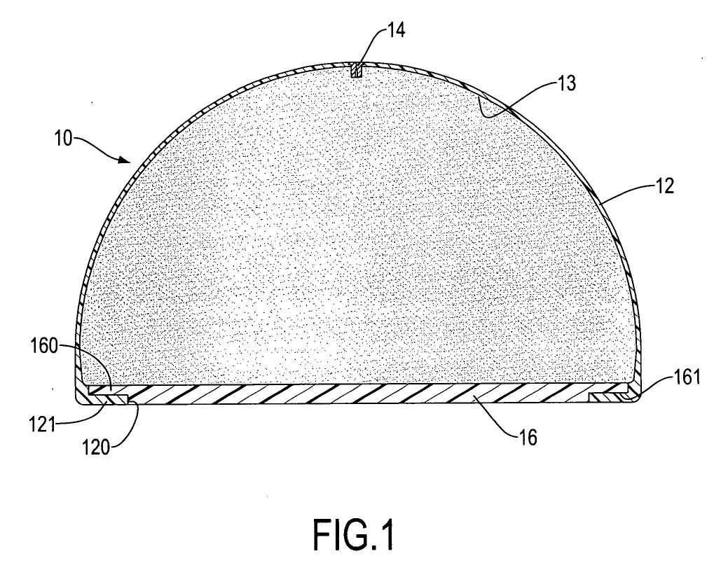

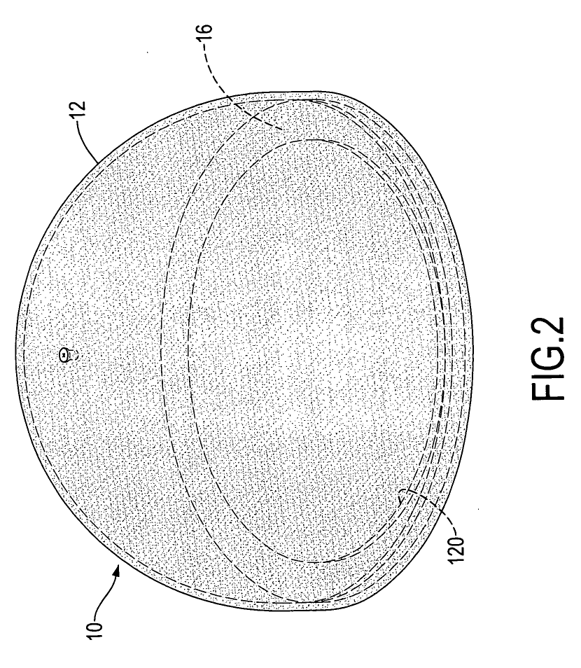

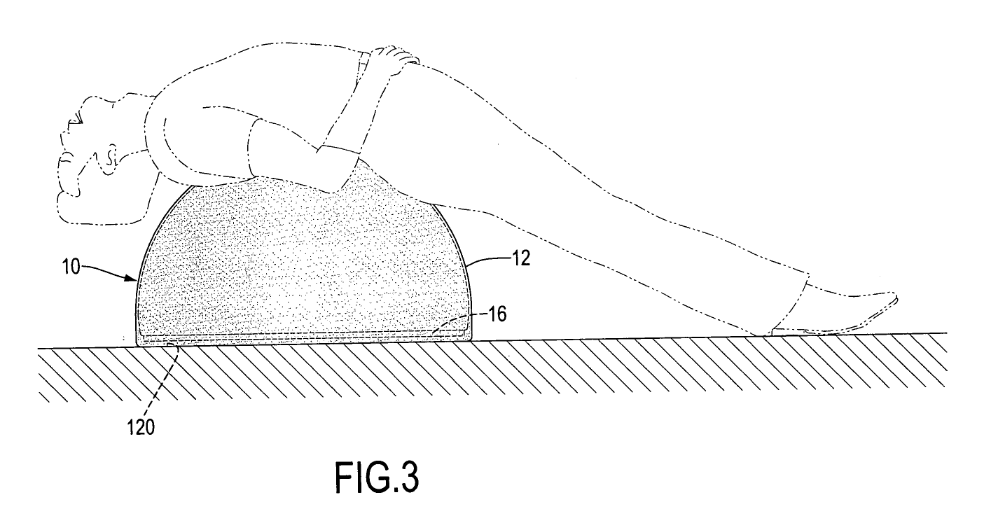

With reference to FIGS. 1 to 3, a sport cushion (10) in accordance with the present invention has a hemispherical top (12), a valve (14) and a supporting base (16).

The hemispherical top (12) has a bottom, an annular lip (121) and an opening (120). The opening (120) is defined in the bottom of the hemispherical top (12). The annular lip (121) is formed around the opening (120).

The valve (14) is mounted on the hemispherical top (12) for air being pumped into the cushion (10).

The supporting base (16) is mounted on bottom of the hemispherical top (12) to seal the opening (120). In a preferred embodiment, the supporting base (16) is mounted on the annular lip (121) of the hemispherical top (12) to seal the opening (120) and forms an air bag (13) between the hemispherical top (12) and the supporting base (16). Therefore, the sport cushion (10) is flexible caused by the air pressure in the air bag (13). The supporting base (16) has a top edge and an annular tongue (161). The annular tongue (161) is formed on the top edge and is mounted on the annular lip (121) of the hemispherical top (12). The method of mounting the supporting base (16) to the annular lip (121) may be binding or heat melting.

Because the sport cushion (10) has the supporting base (16) mounted inside, the sport cushion (10) will not be moved easily when a player uses the cushion (10). Furthermore, an exercising effect is provided by extending a user's body with the flexibility of the sport cushion (10).

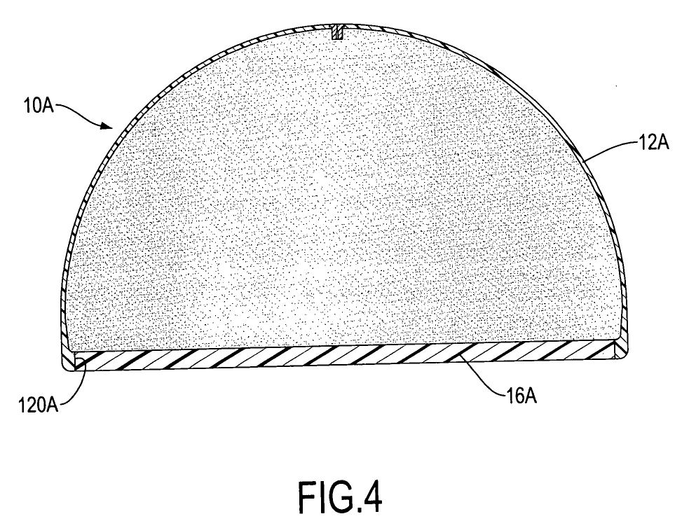

With reference to FIG. 4, a second embodiment of a sport cushion (10A) has a hemispherical top (12A), a valve, and a supporting base (16A). The structure of the second embodiment of the sport cushion (10A) is almost the same as the first embodiment except that the hemispherical top (12A) has an opening (120A) without an annular lip and the supporting base (16A) without an annular tongue. The supporting base (16A) directly mounted inside the opening (120A) in the hemisphere top (12A).

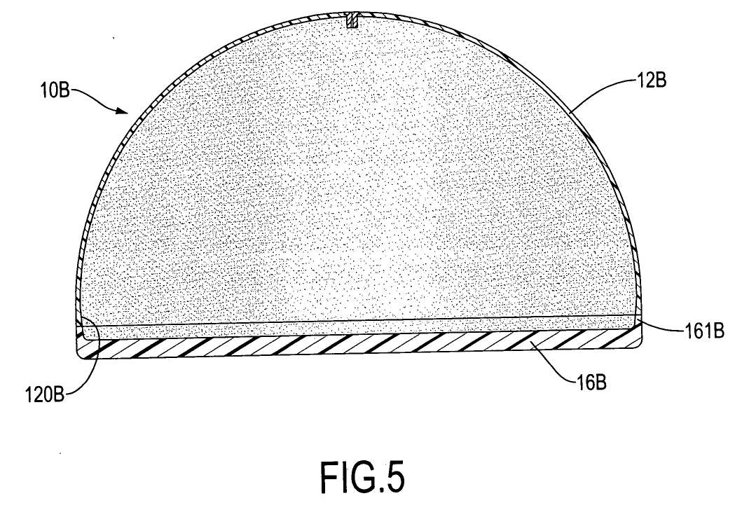

With reference to FIG. 5, a third embodiment of a sport cushion (10B) has a hemispherical top (12B), a valve, and a supporting base (16B). The structure of the third embodiment of the sport cushion (10B) is almost the same as the first embodiment, but the hemispherical top (12B) has an opening (120B) without an annular lip and the supporting base (16B) with an annular top tongue (161B). The annular top tongue (161B) is integrally formed on the top edge of the supporting base (16). The supporting base (16B) directly mounted inside the opening (120B) in the hemispherical top (12B).

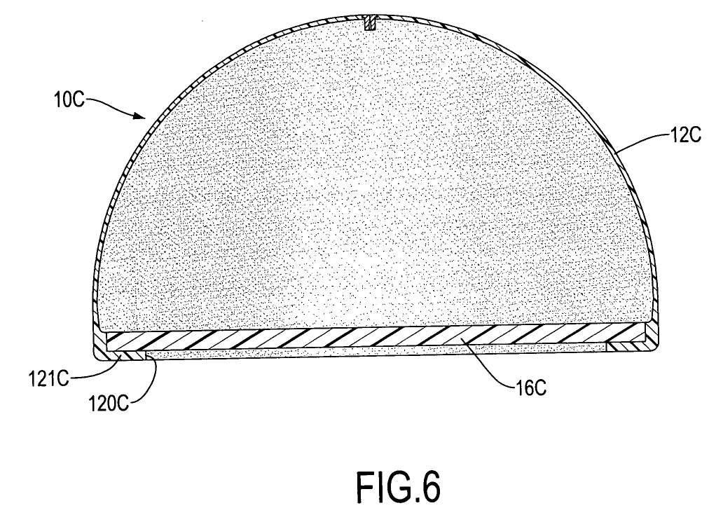

With reference to FIG. 6, a fourth embodiment of a sport cushion (10C) has a hemispherical top (12C), a valve, and a supporting base (16C). The hemispherical top (12C) has a bottom, an annular lip (121C) and an opening (120C) The structure of the forth embodiment of the sport cushion (10C) is almost the same as the first embodiment except the supporting base (16C) without an annular tongue. The supporting base (16C) is directly mounted on the annular lip (121C) to seal the opening (120C).

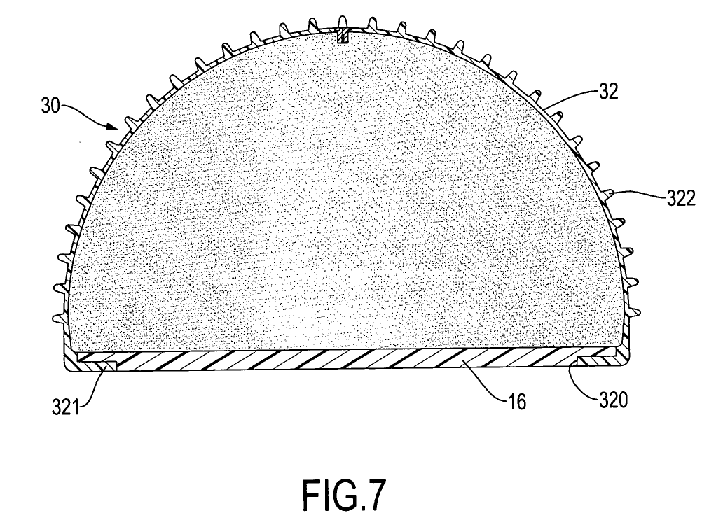

With reference to FIG. 7, a fifth embodiment of a sport cushion (30) has a hemispherical top (32), a valve, and a supporting base (16). The structure of the fifth embodiment of the sport cushion (30) is almost the same as the first embodiment, but the hemispherical top (32) has a bottom, an outer surface, multiple protrudes (322), an annular lip (321) and an opening (320). The annular lip (321) is integrally formed with the bottom of the hemisphere top (32). The multiple protrudes (322) are separately formed on the outer surface of the hemispherical top (32). The supporting base (16) directly mounted on the annular lip (321) to seal the opening (320). When a player uses the sport cushion (30), the multiple protrudes (322) provides a message effect.

The advantages of the sport cushion of the present invention describe as follows.

First, because the supporting base (16, 16A, 16B, 16C) is directly mounted on the hemisphere top (12, 12A, 12B, 12C, 32) to seal the opening (120, 120A, 120B, 120C, 320), the sport cushion doesn't need further plastic material for forming a bottom. Therefore, the cost for manufacturing the sport cushion (10) is lowered.

Second, because the supporting base (16, 16A, 16B, 16C) may be put in a mold firstly, then the hemispherical top (12, 12A, 12B, 12C, 32) is formed with the mold and integrally combined with the supporting base (16, 16A, 16B, 16C), the fabricating process of the sport cushion is convenient and the defect rate is reduced.

Third, with a less cost and safety in use, the sport cushion in accordance with the present invention is competitive in market.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sport cushion comprising:
a top having
a bottom, and
an opening defined in bottom,
a valve mounted on the hemispherical top, and
a supporting base mounted on the bottom of the hemispherical top to seal the opening.

2. The sport cushion as claimed in claim 1, wherein the top is a hemispherical top.

3. The sport cushion as claimed in claim 2, wherein the hemispherical top further comprises an annular lip formed around the opening, and
the supporting base further comprises
a top edge, and
an annular tongue integrally formed on the top edge and combined with the annular lip of the hemispherical top.

4. The sport cushion as claimed in claim 3, wherein the supporting base further comprises a top edge and an annular top tongue integrally formed on the top edge of the supporting base and combined with the bottom of the hemispherical to seal the opening in the hemispherical top.

5. The sport cushion as claimed in claim 2, wherein the hemispherical top further comprises an annular lip formed on the bottom, and
the supporting base is mounted on the annular lip of the hemispherical top.

6. The sport cushion as claimed in claim 3, wherein the hemispherical top further comprises an outer surface and multiple protrudes separately formed on the outer surface of the hemispherical top.
